(19) United States
(12) Patent Application Publication
(10) Pub. No.: US 2003/0136611 A1
(43) Pub. Date: Jul. 24, 2003

(54) Installing frame for installation of shaft equipment, installing elevator with installing frame and method of installation of shaft equipment

(76) Inventors: Karl Erny, Unterageri (CH); Alexander Schottle, Stuttgart (DE); Sonja Glanzmann, Luzern (CH)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/184,263

(22) Filed: Jun. 26, 2002

(30) Foreign Application Priority Data
Jun. 26, 2001 (EP) 01810624.5

(51) Int. Cl. B66B 9/187

(52) U.S. Cl. 187/900

(57) ABSTRACT

An apparatus and method for installing elevator shaft equipment includes utilizing an installing elevator to transport guide rail sections upwardly in an elevator shaft. The installing elevator includes an installing frame having at least one installation platform from which one or more movable parts can be retractably extended to change the size of the support area. Thus, the installing frame can be used for elevator shafts having different cross-sectional areas. At the completion of the shaft equipment installation, an elevator car is attached and the installing frame becomes part of the permanent elevator installation.

### BACKGROUND OF THE INVENTION

The present invention relates to an installing frame for the installation of elevator shaft equipment, to an installing elevator and to a method of installation of elevator shaft equipment.

The European patent document EP 0 501 140 shows an installing frame having working planes that are arranged at an elevator car support frame. The car support frame is raised by an auxiliary lifting device and a cable-pull cable is used for the transport of material. A disadvantage with this known solution is that the work planes are usable only for specific shaft sizes, which leads to a restricted use of the installing frame. A further disadvantage is that there is used, for the installing of the shaft equipment, auxiliary means, for example the cable-pull for the material transport, which are no longer used after the installing and thus have to be removed. This leads to considerable installation times and material wastage.

### SUMMARY OF THE INVENTION

The apparatus according to the present invention has the advantage of using an installing frame, an installing elevator and a method of installation of shaft equipment which apparatus and method do not have the aforesaid disadvantages and which enable saving of time as well as saving of material in the installing of the elevator.

Another advantage is the use of the same installing frame in different elevators and in elevator shafts with different cross-sections. At the same time, there can be used from the outset for the installing elevator components which after the installing are also used for the definitive elevator.

A further advantage is that the installing elevator is a complete elevator inasmuch as it can be used for the transport of the elevator components to be installed, for example the guide rails.

Moreover, it is advantageous that, at the conclusion of the installing, the elevator can be driven by the same elevator motor. This is achieved by mounting the elevator motor at the outset at the correct location. In addition, the support cables used at the outset are the support cables of the operating elevator installation.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view of an installing frame according to the present invention with platforms in a retracted state;

FIG. 2 is a perspective view of the installing frame of FIG. 1 with the platforms in an extended state;

FIG. 3 is a side elevation view of the installing frame of FIG. 2;

FIG. 4 is a perspective view of one of the platforms of FIG. 1 in the retracted state;

FIG. 5 is a perspective view of the platform of FIG. 4 in the extended state; and

FIGS. 6, 7, 8 and 9 are elevation views of the installing elevator according to the present invention in four different phases of the installing operation.

### DESCRIPTION OF THE PREFERRED EMBODIMENT

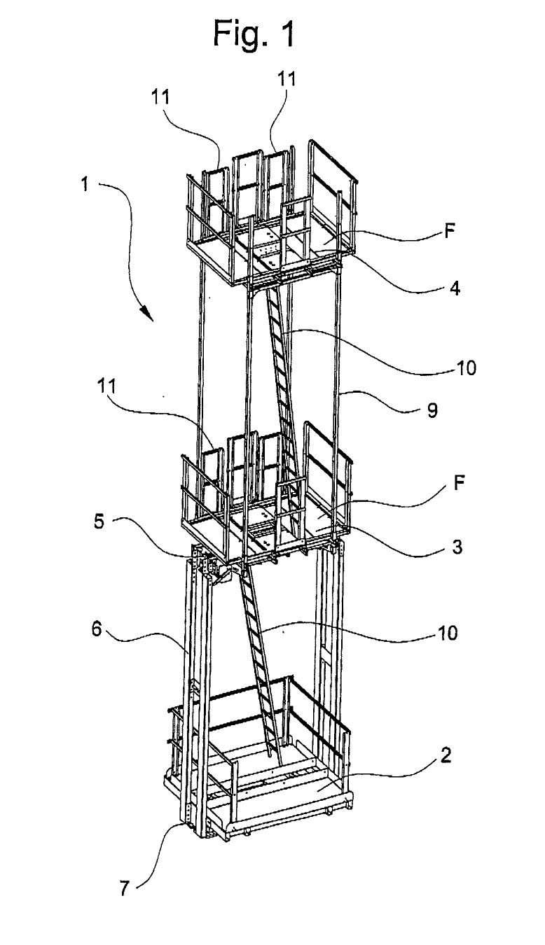

FIG. 1 shows an installing frame 1 according to the present invention including a lower installation platform 2, a middle installation platform 3 and an upper installation platform 4, which function as respective work planes and each of which has a substantially rectangular shape. The installation platforms 2, 3 and 4 are each referred to as “platform” in the following description. The middle platform 3 is built onto an upper yoke 5 of a safety frame 6, which frame after the installing operations is provided for reception of an elevator car. The lower platform 2 is fastened to a lower yoke 7 of the safety frame 6. The middle platform 3 and the upper platform 4 are connected by a tubular frame 9 and braced by tensioning cables (not shown) in order to achieve better stability. It is possible for workers to pass from platform to platform with the help of ladders 10. The middle platform 3 and the upper platform 4 each have an area F which is formed as a stand surface, as well as movable parts 11 which, through their mobility, can vary the area F of the platform. The movable parts 11 are constructed as further stand surfaces. In FIG. 1, the movable parts 11 are illustrated in a driven-in or retracted state.

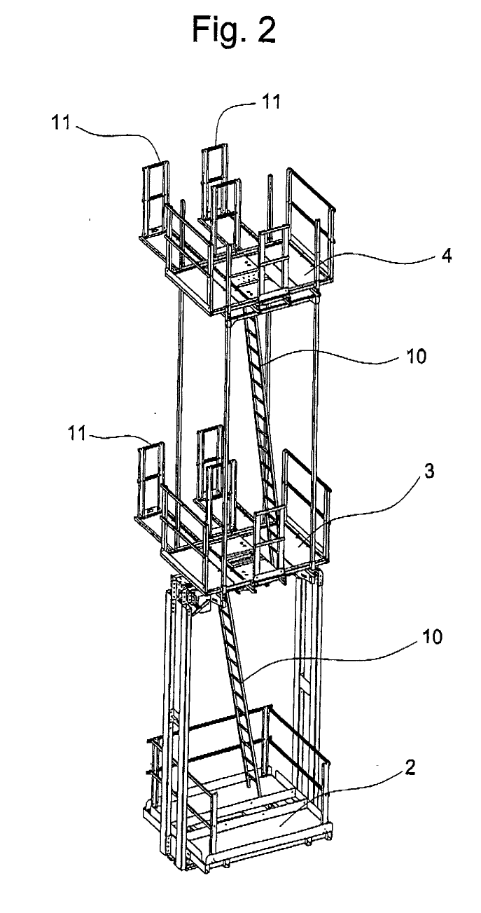

FIG. 2 shows the same installing frame 1 as is shown in FIG. 1, wherein the movable parts 11 of the middle platform 3 and the upper platform 4 are shown in a driven-out or extended state. In this embodiment of the frame 1, the movable parts 11 are movable relative to only one edge of the respective platform. The movable parts 11 can obviously be arranged so that they are movable relative to any of the four edges of the platforms. The size of the area F of the rectangular platform 3 or 4 can thus be added to in all four directions in order to be able to adapt the platforms to, for example, different shaft sizes.

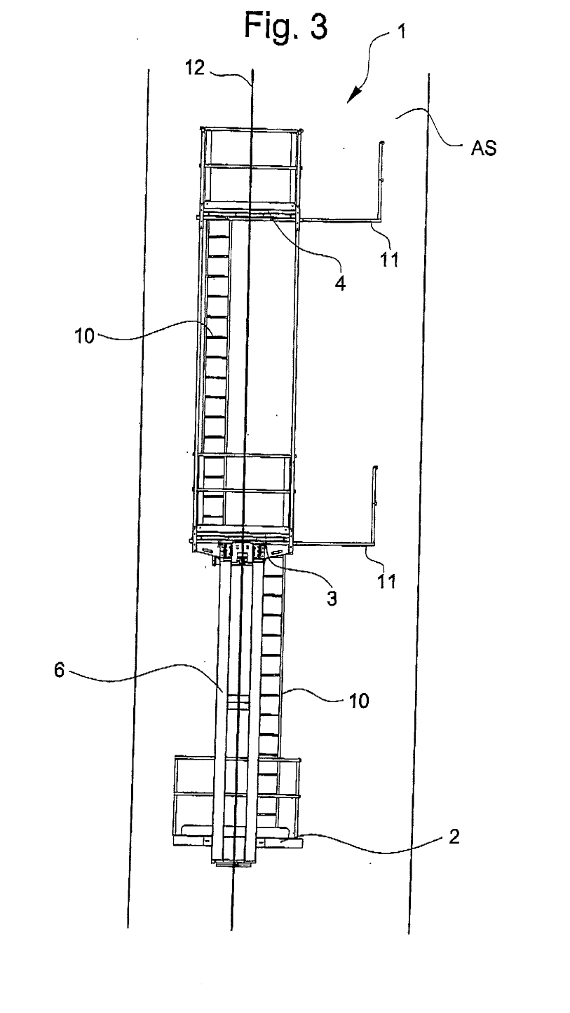

FIG. 3 shows the installing frame 1 according to FIG. 2, wherein a guide rail 12 is positioned in an elevator shaft AS. The safety frame 6 together with the installing frame 1 are guided along the guide rail 12 and a second guide rail (not shown) for vertical movement in the lift shaft AS.

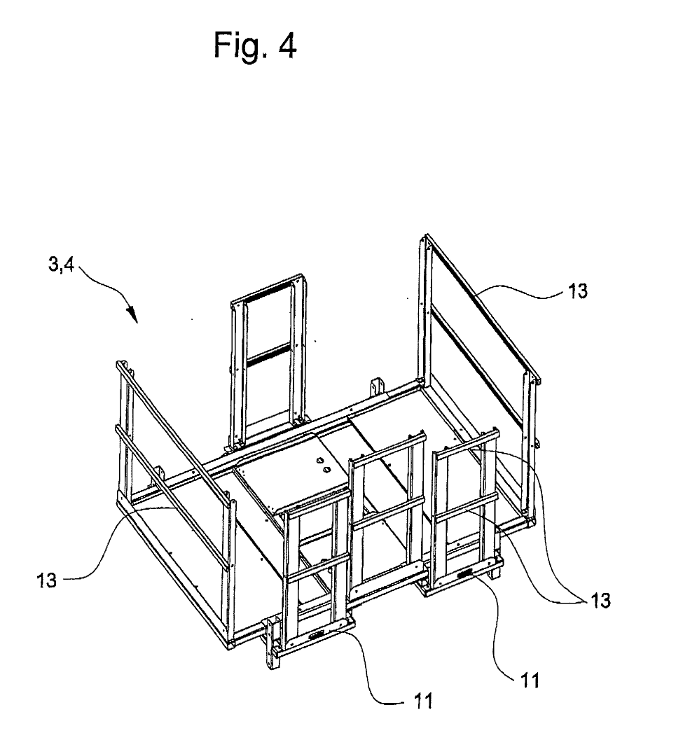

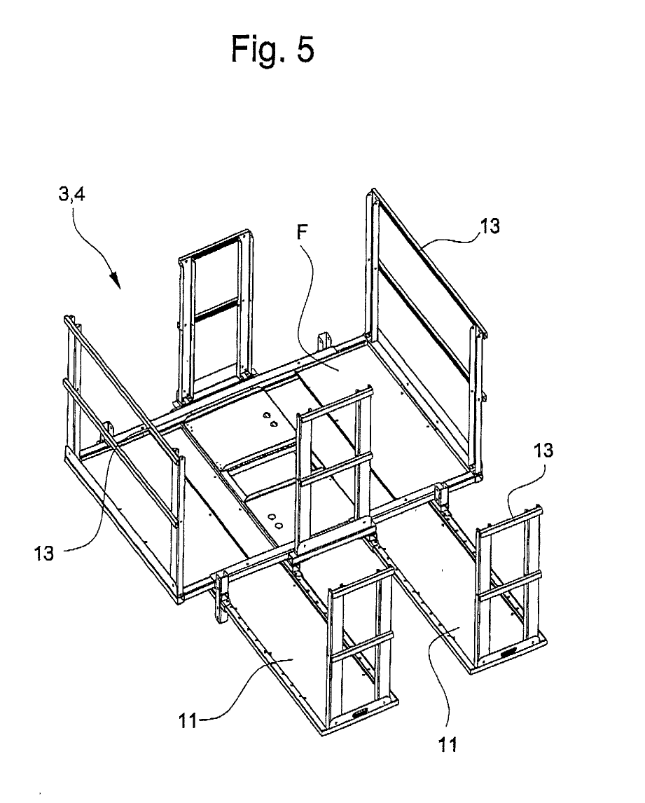

The middle platform 3 or the upper platform 4 of the installing frame 1 is shown in detail in FIGS. 4 and 5. In this example, the platform 3 or 4 has two of the movable parts 11, which parts are shown in FIG. 4 in the retracted state and in FIG. 5 in the extended state. For the sake of safety, the platform 3 or 4 has vertically upwardly extending safety barriers 13 attached at the outer edges thereof. The movable parts 11 also have the safety barriers 13 on the side edges thereof facing the shaft wall.

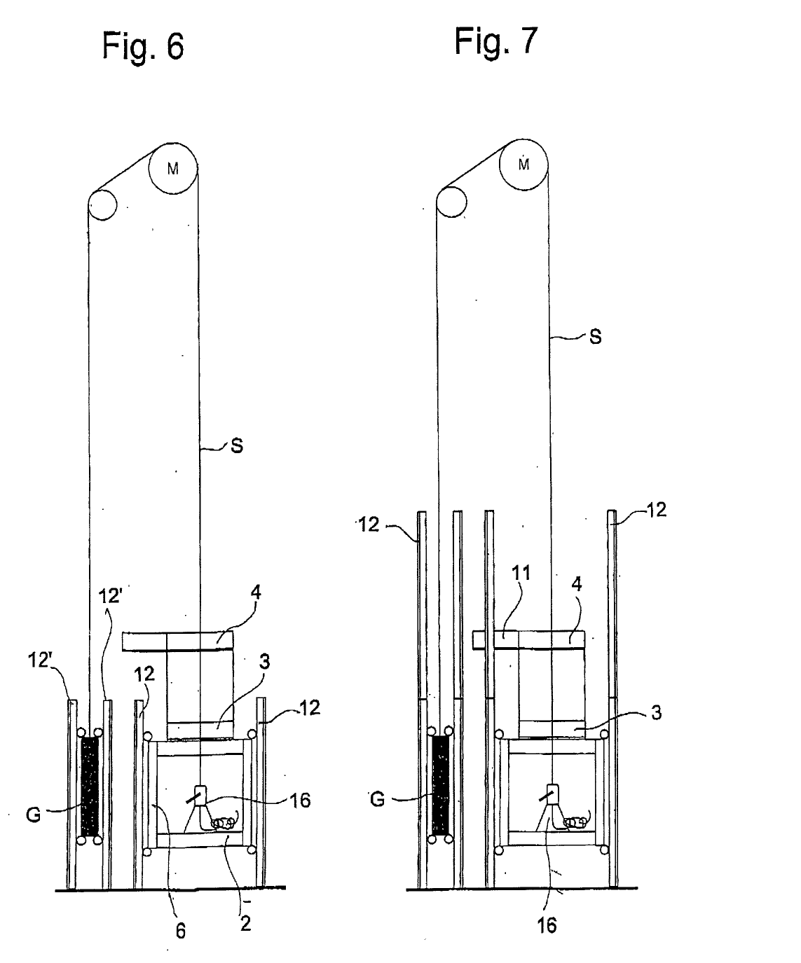

An installing elevator and a method of installation of shaft equipment are described in more detail below with reference to FIGS. 6, 7, 8 and 9. The installing elevator includes the safety frame 6, the installing frame 1 with the three platforms 2, 3 and 4, an elevator motor M and a counterweight G. Initially (FIG. 6) a shaft pit set is mounted and a first section of the guide rails 12 for the safety frame 6, which later serves for reception of the elevator car, and a first section of guide rails 12′ for the counterweight G are placed. In a preferred embodiment the motor M is mounted at the upper end of the shaft AS since it will be the definitive motor for the elevator installation. The counterweight G and the safety frame 6 are then mounted and placed on the buffer. The three platforms 2, 3 and 4 are attached to the safety frame 6. Support cables S are mounted at the counterweight G in a conventional manner and fastened, over the drive pulley of the motor M, to the safety frame 6 by means of a cable tightening device 16. The cable tightening device 16 can be, for example, a lifting device, a winch, a windlass or similar devices. The mounted support cables S are the definitive support cables used for the operating elevator installation. Further sections of the guide rails 12 for the safety frame 6 and further sections of the guide rails 12′ for the counterweight G are mounted from the platforms 2, 3 and 4 (FIG. 7) insofar as this is possible. The platforms 2, 3 and 4 of the installing frame 1 are adapted to the cross-section of the elevator shaft AS. In FIG. 7, the guide rails 12′ of the counterweight G are mounted from the extended movable parts 11 of the upper platform 4. The safety frame 6 together with the installation platforms 2, 3 and 4 is now (FIG. 8) drawn up with the help of the cable tightening device 16 until a guide shoe of the safety frame 6 reaches the end of the uppermost section of the rails 12 and 12′. The safety frame 6 together with the installation platforms (FIG. 9) can now already function as an installing elevator in the region of the sections of the guide rail 12 and 12′ that have been placed. Further rail sections are then picked up by the installing lift 1 and moved up to the upper end of the already installed sections of the guide rails 12 and 12′. The further rail sections are mounted there. The installing elevator thus works up in the shaft AS until the entire shaft is equipped with the rails 12 and 12′. There is thus made available a complete elevator that can be used for the transport of the elevator components that are to be installed, for example the guide rails 12 and 12′, from the ground floor.

At the end of the installation process the safety frame 6 of the elevator car is in the correct position relative to the counterweight G, so that the support cables S can be shortened to the correct length and directly connected with the safety frame 6. With respect to the elevator cables, the elevator is thus provided with cabling to a finished state. The cut-off parts of the cables can be used as, for example, compensating cables. Thus, no waste occurs. The cable tightening device 16 can now be removed.

The motor M is, in a preferred embodiment, the definitive motor of the elevator installation. The motor M is mounted at the beginning of the installation process so that the cables S can be mounted over the drive pulley. During the installing travels the installing elevator is moved by the elevator motor M. At the conclusion of the installing process, the elevator continues to move by the same motor M.

It would also be conceivable to install a small auxiliary motor in order to realize a “jump elevator”. This means that the motor is installed at a specific floor during the construction phase and the installing elevator is then used as a construction elevator. As the building continues to grow, the motor is placed at a higher floor, the rails are installed to the new height and the elevator travels over the new lift height as a construction elevator. When the final building height is reached the definitive motor M is installed, the rails are installed to the final height and the elevator then goes into normal operation.

Although it has not been explicitly shown here, the installing elevator travels from the start with all necessary items of equipment, such as safety brake, speed limiter, guide shoe, buffer, counterweight, compensating cables if necessary, safety brake at the counterweight, etc. It is a complete elevator that does not have a car and can travel only by inspection travel (no control, no floor call, etc.).

The area F or the stand surface of the platforms is, as explained above, able to be enlarged by extending one or more of the movable parts 11.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An installing frame for the installation of shaft equipment in an elevator shaft comprising:
a frame adapted to engage and be guided by a guide rail extending along an elevator shaft;
at least one installation platform attached to said frame and having a support area of a predetermined size less than a cross-sectional area of the elevator shaft; and
at least one movable part attached to said at least one installation platform, said at least one movable part being extensible beyond an edge of said at least one installation platform for expanding said support area.

2. The installing frame according to claim 1 wherein said support area is constructed as a stand surface for a person and said movable part enlarges said stand surface when extended.

3. The installing frame according to claim 1 including another installation platform attached to said frame and spaced vertically from said at least one installation platform, said another installation platform having a support area of a predetermined size less than the cross-sectional area of the elevator shaft.

4. The installing frame according to claim 3 including another movable part attached to said another installation platform, said another movable part being extensible beyond an edge of said another installation platform for expanding said support area.

5. The installing frame according to claim 1 including another movable part attached to said at least one installation platform, said another movable part being extensible beyond an edge of said at least one installation platform for expanding said support area.

6. An installing elevator for the installation of shaft equipment in an elevator shaft comprising:
a safety frame adapted to engage and be guided by a guide rail extending along an elevator shaft;
an installing frame attached to said safety frame;
at least one installation platform attached to said installing frame and having a support area of a predetermined size less than a cross-sectional area of the elevator shaft; and
at least one movable part attached to said at least one installation platform, said at least one movable part being extensible beyond an edge of said at least one installation platform for expanding said support area.

7. The installing elevator according to claim 6 including a counterweight connected with said safety frame by at least one support cable.

8. The installing elevator according to claim 7 including an elevator motor engaging said at least one support cable and adapted to be mounted in the elevator shaft.

9. The installing elevator according to claim 6 wherein said support area is constructed as a stand surface for a person and said movable part enlarges said stand surface when extended.

10. The installing elevator according to claim 6 including another installation platform attached to said installing frame and spaced vertically from said at least one installation platform, said another installation platform having a support area of a predetermined size less than the cross-sectional area of the elevator shaft.

11. The installing elevator according to claim 10 including another movable part attached to said another installation platform, said another movable part being extensible beyond an edge of said another installation platform for expanding said support area.

12. The installing elevator according to claim 6 including another movable part attached to said at least one installation platform, said another movable part being extensible beyond an edge of said at least one installation platform for expanding said support area.

13. A method for installing shaft equipment in an elevator shaft comprising the steps of:
a. positioning an installing elevator at a bottom of an elevator shaft, the installing elevator having at least one platform;
b. providing lower sections of guide rails extending upwardly from the bottom of the elevator shaft;
c. adjusting a size of a support area of the platform based upon a cross-sectional area of the elevator shaft; and
d. transporting elevator shaft equipment on the support area of the platform by moving the installing elevator upwardly along the guide rails.

14. The method according to claim 13 wherein said step c. is performed by extending at least one movable part from an edge of the platform.

15. The method according to claim 13 wherein said step d. is performed by initially drawing the installing elevator up the guide rails from the bottom of the elevator shaft for a predetermined distance utilizing a cable tightening device connected between the installing elevator and a support cable and then driving the installing elevator upwardly in the elevator shaft utilizing an elevator motor mounted in the elevator shaft and engaging the support cable.

16. The method according to claim 13 wherein said step d. is performed by transporting sections of at least one of the guide rails for the installing elevator and guide rails for a counterweight attached to the support cable.
